(19) United States
(12) Patent Application Publication
(10) Pub. No.: US 2002/0024534 A1
(43) Pub. Date: Feb. 28, 2002

(54) D-Book (Dialogue Book) system and method

(76) Inventor: Samuel Sergio Tenembaum, New York, NY (US)

Correspondence Address: SAMUEL TENEMBAUM, 2nd Floor, 34 East 67th Street, New York, NY, 10011, US

(21) Appl. No.: 09/928,711

(22) Filed: Aug. 13, 2001

Related U.S. Application Data
(60) Provisional application No. 60/229,145, filed on Aug. 31, 2000.

(51) Int. Cl. G06F 3/00

(52) U.S. Cl. 345/733

(57) ABSTRACT

A new method that contemplates a new kind of book format, the D-Book (dialogue Book). D-Books are totally online, free of charge, interactive, browser-driven, and browser-agnostic. In addition, D-Books enhance the Reader's experience through an extensive net of hyperlinks to external sites relevant to its contents.

This application claims the benefit of U.S. Provisional Application No. 60/229,145 filed in the U.S. Patent and Trademark Office on Aug. 31, 2000; the entire contents of the aforementioned Provisional Application being hereby incorporated by reference.

### FIELD OF THE INVENTION

The present invention relates generally to a new kind of online interactive book format, hereinafter referred to as the “D-Book”, and more particularly it relates to a business method to implement this invention.

### BACKGROUND

The Internet has revolutionized many areas, including book publishing. Amidst this revolution, Electronic Books (E-books) are making their appearance in the market. However, the existing models of E-books don't seem to take full advantage of the endless possibilities of the new medium. Instead, they seem to be “cut and paste” versions of traditional paper books. In other words, E-books try to give the reader a familiar impression by copying the format of existing books. As opposed to the E-Book, our D-Book was specially conceived for the Internet environment, taking full advantage of the striking features of this medium. The D-Book is first and foremost a Dialogue Book, which allows maximum ongoing interactivity with its readers. In this sense, the D-Book is a dynamic, ever changing book thanks to the constant input fed by its readers. Furthermore, the D-Book is an Internet Book, extensively hyper-linked with external sites, relevant to its contents. It also features internal hyper-links within different sections and chapters of the D-Book itself, thus granting the reader an enlightening and amusing experience.

Additionally, unlike the E-Books, the D-Books are completely browser-driven, namely the readers will not need plug-ins to read them.

### SUMMARY

The D-Book features a number of innovations and advantages over the existing E-Book models, such as:

1. Dialogue and Openness: Due to its dialogue component, the D-Book experience will be particularly but not exclusively suitable for non-fiction books. The original authors of D-Books will acknowledge the fact that their books will become constantly developing entities, thanks to the active participation of the readers, who will post their comments, suggestions, alternative passages, reviews, amendments, etc. in an online forum especially devoted for that purpose. In other words, the D-Books will be open and interactive.

2. Universality: The D-Books will feature a wide net of hyperlinks with external websites relevant to their contents, thus enhancing the reader's experience. For the sake of convenience, the external links will open inside the D-Book itself, so that the reader can easily go back to his original reading. These hyperlinks will be constantly updated, thus granting a sense of liveliness and ongoing relevance to the D-Book.

3. Advertising-sponsored business model: In our preferred embodiment, the D-Books will be sponsored by advertisers, so that the readers will access them totally free of charge. The preferred advertising method will be the “Shoshkele” (™) animations. Other online advertising methods (such as banners, interstitials, etc.) will also be contemplated.

4. Community Experience: The D-Books will feature special online fora where the readers will be able to exchange anything from punctual views regarding the D-Book in question, up to general literary preferences.

5. Browser-driven Experience: D-Books will not require any plug-ins nor any special reading software. They will be browser-driven and browser-agnostic, so that any Internet surfer will be able to access them, using his/her usual Internet Browser.

6. Freedom of use: The readers of D-Books will be able and entitled to print them, give them away as gifts or forward them by email to friends.

### BRIEF DESCRIPTIONS OF THE DRAWINGS

The foregoing brief description, as well as further objects, features and advantages of the present invention will be understood from the following detailed description of presently preferred embodiments, with reference being had to the accompanying drawing, in which:

FIG. 1 is a block diagram illustrating the D-Book business model. The main players are the Original Author, the Editor and the Readers.

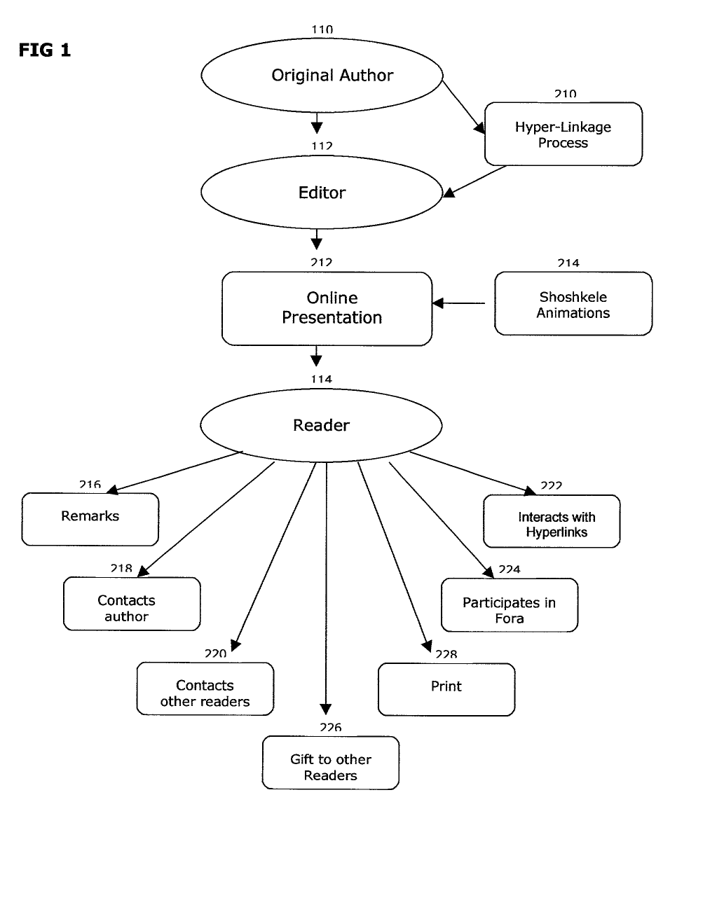

### DETAILED DESCRIPTION

These and other aspects of the invention will now be described in greater detail in connection with a number of exemplary embodiments.

The present invention provides a method of granting a unique reading experience to anyone who has an Internet connection or anyone at large who can get a print of the book from someone who has an Internet connection.

The method comprises the following steps:

The Original Author 110 presents his/her manuscript to the Editor 112 for review and proof-reading.

Together, Original Author 110 and Editor 112 implement the Hyper-linkage Process 210, whereby certain words, names and passages of the D-Book will be linked to outside reference websites.

Once the review, proof-reading and Hyper-linkage processes are completed, the D-Book goes online (Online Presentation 212), on a specific website URL.

The Reader 114 with an Internet connection, accesses the D-Book by entering the proper URL and embarks in the reading experience by browsing the internal and external links. During this time, Shoshkele™ animations 214 pop-up in a randomic fashion with advertising contents relevant to the Reader.

During the reading experience, the Reader can input his/her remarks (216), contact the author (218), contact other readers (220), interact with the D-Books hyperlinks (222) or participate in various fora (224).

What is claimed is:

1. A method of creating an online Dialogue Book (D-Book), that enables readers to engage in a unique interactive experience by posting their own comments, remarks, thoughts and suggestions, as a form of interaction with other readers or with the Author, all this becoming an integral part of the D-Book.

2. The method of claim 1., wherein the D-Book is completely free of charge thanks to sponsors who advertise Shohekele™ ads on the D-Book website.

3. The method of claim 1., wherein the D-Book is completely free of charge thanks to sponsors who advertise online ads (such as banners, rich-media banners, interstitials, etc.) on the D-Book website.

4. The method of claim 1., wherein the reader has to pay a subscription or a pay per view fee to access the D-Book.

5. The method of claim 1., wherein the D-Book features internal and external hyperlinks, which can be easily activated by the Readers.
